(19) United States
(12) Patent Application Publication
(10) Pub. No.: US 2026/0040339 A1
(43) Pub. Date: Feb. 5, 2026

(54) SYSTEMS AND METHODS FOR DFS CAPABLE AND DFS NON-CAPABLE CLIENT IDENTIFICATION

(71) Applicant: Nile Global, Inc., San Jose, CA (US)

(72) Inventors: Guru Prasanna Gopalakrishnan, San Jose, CA (US); Abhiruchi Dakshinkar, Fremont, CA (US)

(21) Appl. No.: 18/794,867

(22) Filed: Aug. 5, 2024

(51) Int. Cl. H04W 72/51; H04W 84/12

(52) U.S. Cl. CPC H04W 72/51; H04W 84/12

(57) ABSTRACT

Creating a channel allocation specification may require setting dynamic frequency selection (DFS) capability indicators corresponding to a plurality of clients in response to receiving client capability metadata related to those clients. The DFS capability indicators may indicate the clients that are DFS capable clients and the clients that are DFS non-capable clients. The DFS capability indicators may be provided to a channel allocator that is configured to produce a channel allocation specification for a wireless network that includes a plurality of wireless access points configured to use a plurality of DFS channels and a plurality of non-DFS channels to provide network access to the clients, the channel allocation specification based at least in part on the client capability metadata.

### TECHNICAL FIELD

The systems and methods relate to wireless networks, WiFi networks, dynamic frequency selection (DFS) channels, non-DFS channels, and to channel allocation. The systems and methods also relate to allocating non-DFS channels and DFS channels among the wireless access points in a wireless network.

### BACKGROUND

Wireless networks such as WiFi networks have been widely deployed and are widely used. The Institute of Electrical and Electronics Engineers (IEEE) has produced and maintains the standards for WiFi. These standards are identified as the 802.11 standards. The 802.11 family of standards specify many aspects of WiFi communications, including the channels that may be used for WiFi communications. The channels that may be used for WiFi communications include DFS channels and non-DFS channels. The DFS channels are channels that may be used for WiFi but that may also be used by other devices, such as military radar, satellite communications, weather radar, etc. It may therefore be advantageous to use the non-DFS channels in order to avoid interference from such devices. In fact, many WiFi devices are designed such that they only use non-DFS channels. Alternatively, it may be advantageous to use DFS channels in order to avoid interference with other WiFi devices. Systems and methods for DFS aware wireless network channel allocation are needed.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

One aspect of the subject matter described in this disclosure can be implemented by a method. The method may include producing a plurality of dynamic frequency selection (DFS) capability indicators corresponding to a plurality of clients in response to receiving client capability metadata, the DFS capability indicators indicating the clients that are DFS capable clients and the clients that are DFS non-capable clients, and providing the DFS capability indicators to a channel allocator that is configured to produce a channel allocation specification for a wireless network that includes a plurality of wireless access points configured to use a plurality of DFS channels and a plurality of non-DFS channels to provide network access to the clients, the channel allocation specification based at least in part on the client capability metadata.

Yet another aspect of the subject matter described in this disclosure can be implemented by a non-transitory computer storage medium storing computer readable instructions. The computer readable instructions may, when executed on one or more processors, implement a method that includes producing a plurality of dynamic frequency selection (DFS) capability indicators corresponding to a plurality of clients in response to receiving client capability metadata, the DFS capability indicators indicating the clients that are DFS capable clients and the clients that are DFS non-capable clients, and providing the DFS capability indicators to a wireless network configurator that is configured to produce a channel allocation specification for a wireless network that includes a plurality of wireless access points configured to use a plurality of DFS channels and a plurality of non-DFS channels to provide network access to the clients, the channel allocation specification based at least in part on the client capability metadata.

Yet another aspect of the subject matter described in this disclosure can be implemented by a system. The system may include a means for receiving client capability metadata from a plurality of clients that include a plurality of DFS capable clients and a plurality of DFS non-capable clients, a production means for producing a dynamic frequency selection (DFS) capability indication means for indicating the clients that are the DFS capable clients and the clients that are the DFS non-capable clients, a provider means for providing the capability indication means to a channel allocator means for producing a channel allocation specification for a plurality of access means for using a plurality of DFS channels and a plurality of non-DFS channels to provide network access to the clients, wherein the production means produces the DFS capability indication means in response to receiving the client capability metadata, and channel allocator means produces the channel allocation specification in response to receiving the client capability metadata.

In some implementations of the methods and devices, the client capability metadata is received from the clients via the wireless access points. In some implementations of the methods and devices, producing the DFS capability indicators includes setting the DFS capability indicators to indicate a one of the clients is a DFS capable client in response to determining that the client capability metadata indicates that the one of the clients is a Wi-Fi network monitor. In some implementations of the methods and devices, producing the DFS capability indicators includes setting the DFS capability indicators to indicate a one of the clients is a DFS capable client in response to determining that the client capability metadata indicates that the one of the clients is configured to use a plurality of channels that includes one of the DFS channels. In some implementations of the methods and devices, producing the DFS capability indicators includes setting the DFS capability indicators to indicate a one of the clients is a DFS capable client in response to determining that the client capability metadata indicates that the one of the clients is configured to use a plurality of channels that includes every one of the DFS channels in a current regulatory domain. In some implementations of the methods and devices, producing the DFS capability indicators includes setting the DFS capability indicators to indicate a one of the clients is a DFS capable client in response to determining that the client capability metadata indicates that the one of the clients is configured to use an operating class that includes one of the DFS channels.

In some implementations of the methods and devices, the method may further include receiving client resource usage metadata indicating resource usage by the clients, and associating a DFS noncapable client with a wireless access point based on the client resource usage metadata, wherein the DFS noncapable client is one of the DFS noncapable clients, and the wireless access point is one of the wireless access points. In some implementations of the methods and devices, associating the DFS noncapable client with the wireless access point based on the client resource usage metadata includes using the client resource usage metadata to determine that a connected time between the DFS noncapable client and the wireless access point is a maximum of a plurality of connected times between the DFS noncapable client and the wireless access points. In some implementations of the methods and devices, associating the DFS noncapable client with the wireless access point based on the client resource usage metadata includes using the client resource usage metadata to determine that a connected time between the DFS noncapable client and the wireless access point is a maximum of a plurality of connected times between the DFS noncapable client and the wireless access points, and using the client resource usage metadata to determine that an average signal strength between the DFS noncapable client and the wireless access point is a maximum of a plurality of average signal strengths between the DFS noncapable client and the wireless access points. In some implementations of the methods and devices, associating the DFS noncapable client with the wireless access point based on the client resource usage metadata includes using the client resource usage metadata to determine that a connected time between the DFS noncapable client and a second one of the wireless access points is a maximum of a plurality of connected times between the DFS noncapable client and the wireless access points, using the client resource usage metadata to determine that an average signal strength between the DFS noncapable client and the second one of the wireless access points is below a threshold value, and using the client resource usage metadata to determine that the average signal strength between the DFS noncapable client and the wireless access point is a maximum of the average signal strengths between the DFS noncapable client and the wireless access points.

In some implementations of the methods and devices, the method further includes associating the clients with the wireless access points based on the client resource usage metadata, each client associated with no more than one of the wireless access points, assigning the wireless access points to a first group or to a second group based on the DFS capability indicators and which of the clients are associated with which of the wireless access points, wherein the wireless access points in the first group are each associated with at least one DFS non-capable client, and no wireless access point in the second group is associated with any of the DFS non-capable clients. In some implementations of the methods and devices, the method further includes producing the channel allocation specification, and sending the channel allocation specification to an access point controller that is configured to assign the DFS channels and the non-DFS channels to the wireless access points, wherein the channel allocation specification allocates the DFS channels and the non-DFS channels to the wireless access points, allocating the non-DFS channels to the first group is prioritized over allocating the non-DFS channels to the second group, and allocation of the non-DFS channels within the first group is prioritized based on a plurality of prioritization values corresponding to the wireless access points.

In some implementations of the methods and devices, the clients are associated with the wireless access points in response to receiving client resource usage metadata, each client associated with no more than one of the wireless access points, and allocating the non-DFS channels to the wireless access points that are associated with at least one DFS non-capable client is prioritized over allocating the non-DFS channels to the wireless access points that are associated with none of the DFS non-capable clients.

In some implementations of the methods and devices, the system further includes an association means for associating a DFS noncapable client with a wireless access point based on a client resource usage metadata, wherein the channel allocator means allocates a non-DFS channel to one of the access means in response to determining that the access means provides network access to a DFS non-capable client.

### BRIEF DESCRIPTION OF THE DRAWINGS

FIG. 1 is a high-level block diagram illustrating a wireless network that may be configured using a channel allocator and an access point controller, according to some aspects.

FIG. 2 is a high-level diagram illustrating an example of clients and wireless access points (WAPs) providing metadata to a channel allocator, according to some aspects.

FIG. 3 is a high-level block diagram illustrating an example of a host machine that may implement a channel allocator and an access point controller, according to some aspects.

FIG. 4 is a high-level block diagram illustrating an example of a software system according to some aspects.

FIG. 5 is a high-level conceptual diagram illustrating an example of client capability metadata, according to some aspects.

FIG. 6 is a high-level conceptual diagram illustrating an example of client resource usage metadata, according to some aspects.

FIG. 7 is a high-level conceptual diagram illustrating an example of wireless access point (WAP) additional metadata, according to some aspects.

FIG. 8 is a high-level conceptual diagram illustrating an example of DFS channel and class metadata, according to some aspects.

FIG. 9 is a high-level conceptual diagram illustrating an example of a client analysis table, according to some aspects.

FIG. 10 a high-level flow diagram illustrating an example of a process for determining whether a client is a DFS non-capable client, according to some aspects.

FIG. 11 a high-level flow diagram illustrating an example of a process for identifying the WAPs that provide network access to DFS non-capable clients, according to some aspects.

FIG. 12 is a high-level conceptual diagram illustrating an example of WAP groups, according to some aspects.

FIG. 13 a high-level flow diagram illustrating an example of a process for calculating a priority metric, according to some aspects.

FIG. 14 a high-level flow diagram illustrating an example of a process for producing a channel allocation specification, according to some aspects.

FIG. 15 is a high-level conceptual diagram illustrating an example of a channel allocation specification, according to some aspects.

FIG. 16 a high-level flow diagram illustrating an example of a method for creating a channel allocation specification, according to some aspects.

FIG. 17 a high-level flow diagram illustrating an example of a method for creating a channel allocation specification that is sent to an access point controller, according to some aspects.

FIG. 18 a high-level flow diagram illustrating an example of a cloud service, according to some aspects.

### DETAILED DESCRIPTION

It will be readily understood that the components of the examples as generally described herein and illustrated in the appended figures could be arranged and designed in a wide variety of different configurations. Thus, the following more detailed description of various examples, as represented in the figures, is not intended to limit the scope of the present disclosure but is merely representative of various examples. While the various aspects of the examples are presented in drawings, the drawings are not necessarily drawn to scale unless specifically indicated.

The described examples are to be considered in all respects only as illustrative and not restrictive. The scope of the claimed matter is therefore indicated by the appended claims rather than by this detailed description. All changes which come within the meaning and range of equivalency of the claims are to be embraced within their scope.

Reference throughout this specification to features, advantages, or similar language does not imply that all the features and advantages that may be realized should be realized in any single example. Rather, language referring to the features and advantages is understood to mean that a specific feature, advantage, or characteristic described in connection with an example is included in at least one implementation. Thus, discussions of the features and advantages, and similar language, throughout this specification may, but do not necessarily, refer to the same example.

Furthermore, the described features, advantages, characteristics, and aspects may be combined in any suitable manner in one or more examples. One skilled in the relevant art will recognize from the description herein that one example may be practiced without one or more of the specific features or advantages of another example. In other instances, additional features and advantages may be recognized in certain examples that may not be present in all examples.

Reference throughout this specification to “one example”, “an example”, or similar language means that a particular feature, structure, or characteristic described in connection with the indicated example is included in at least one example. Thus, the phrases “in one example”, “in an example”, and similar language throughout this specification may, but do not necessarily, all refer to the same example.

The channels available for WiFi in the 5G band include DFS channels and non DFS channels. The specific channels that are DFS and non-DFS depend on the regulatory domain. A regulatory domain is a geographic area subject to a specific set of regulations or laws. An example is the U.S. regulatory domain that is subject to U.S. law and regulations. The DFS channels are 52, 56, 60, 64, 100, 104, 108, 112, 116, 120, 124, 128, 132, 136, 140, and 144 in the U.S. The non-DFS channels are 36, 40, 44, 48, 149, 153, 157, 161, and 165 in the U.S. Other countries may have their own regulations that may specify other sets of channels as DES and non-DFS.

Wireless access points (WAPs) operating on DFS channels in the 5G band are prone to abrupt network interruptions due to the presence of active incumbent radar systems in the vicinity or due to false positives with the radar detection mechanism itself. Furthermore, some clients support operating on DFS channels and other clients, the DFS non-capable devices, do not support operating on DFS channels. As such, DFS non-capable clients may be incapable of connecting to nearby WAPs operating on DFS channels. Such DFS non-capable clients may instead have to inefficiently pick far away WAPs operating on non DFS channels, if available, or downgrade to the 2G band, which may result in bad end user experiences such as reduced voice/video call quality. Operating all the WAPs on non-DFS channels may decrease overall network capacity because the DFS channels are a large percentage of the available channels. For example, over half the available 5G channels in the U.S. are DFS channels. It may therefore be desirable to use the DFS channels.

The WiFi standards include specifications for querying WiFi devices for aspects of their capabilities, resource usage, and operating environment. As such, the clients may indicate which channels they can use. Similarly, the WAPs may indicate which clients they serve, the clients' network utilization, and even the amount of interference such as the interference on DFS channels due to non-WiFi sources such as radars operating in the 5G band. The metadata collected from the clients and WAPs may be used to produce a channel allocation specification. Creating the channel allocation specification may prioritize allocation of non-DFS channels to WAPs providing network access to non-DFS clients and to WAPs that experience interference on the DFS channels.

The result is a useful application for allocating WiFi channels. WAPs that serve only DFS capable clients may be allocated DFS channels. Furthermore, WAPs that are unlikely to experience interference on DFS channels may be allocated DFS channels. As such, the available channels may be allocated to the WAPs in a manner that better serves the non-DFS clients, reduces the effects of DFS channel interference, and uses DFS channels to improve overall network capacity.

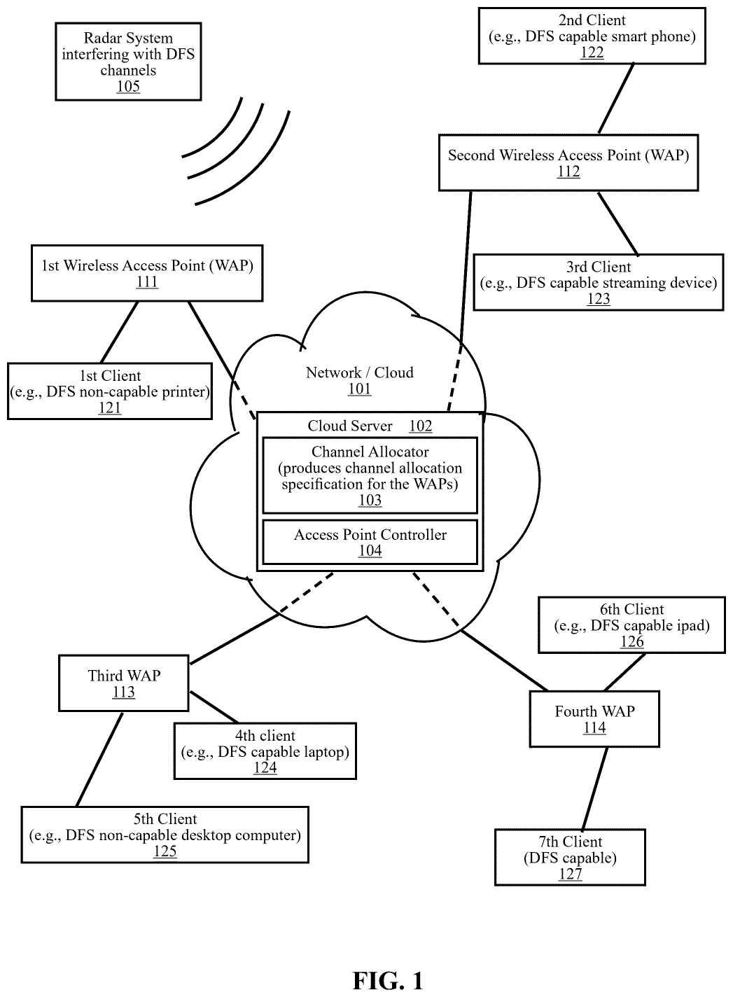

FIG. 1 is a high-level block diagram illustrating a wireless network that may be configured using a channel allocator 103 and an access point controller 104, according to some aspects. The wireless network may have wireless access points such as a first wireless access point (WAP) 111, a second WAP 112, a third WAP 113, and a fourth WAP 114. The WAPs may provide network access to clients such as a first client 121 (e.g., a DFS non-capable printer), a second client 122 (e.g., DFS capable smartphone), a third client 123 (e.g., DFS capable streaming device), a fourth client 124 (e.g., DFS capable laptop), a fifth client 125 (e.g., DFS non-capable desktop computer), a sixth client 126 (e.g., DFS capable iPad), and a seventh client 127 (e.g., another DFS capable device). The WAPs may be connected to each other and to the Internet by a network 101 that may include many wired and wireless devices. A cloud server 102 may be connected to the network 101. The cloud server may be in the same facility as the WAPs or may be located at a distant location such as a data center. The cloud server 102 may run applications such as a channel allocator 103 and an access point controller 104. The channel allocator may produce a channel allocation specification that specifies the channels that the WAPs are to use. The access point controller may configure the WAPs to use the channels as indicated by the channel allocation specification. In the example shown in FIG. 1, a radar system 105 may be interfering with the DFS channels.

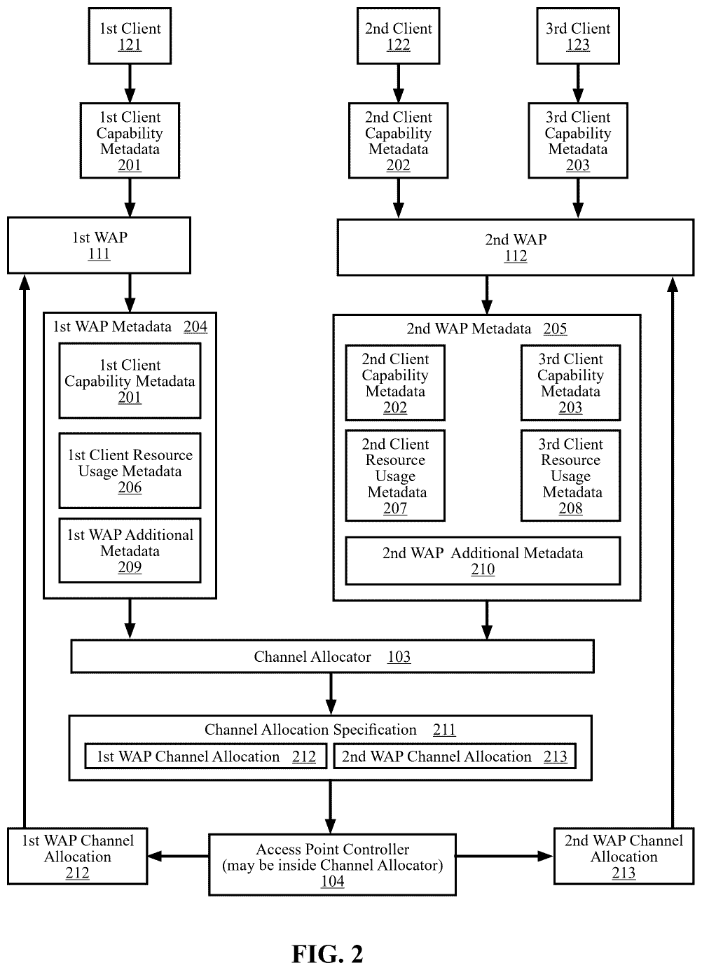

FIG. 2 is a high-level diagram illustrating an example of clients and wireless access points (WAPs) providing metadata to a channel allocator, according to some aspects. In accordance with the WiFi standards, the first WAP 111 may query the first client 121 for its capabilities such as what channels the first client 121 can use. In response to the query, the first client may send first client capability metadata 201 to the first WAP 111. Similarly, the second WAP 112 can receive second client capability metadata 202 from the second client 122 and may receive third client capability metadata 203 from the third client 123. The WAPs may send the client capability metadata to the channel allocator along with additional metadata that the WAPs may store, gather, or produce. As such, the first WAP 111 may send first WAP metadata 204 to the channel allocator 103. The first WAP metadata 204 may include the first client capability metadata 201, first client resource usage metadata 206, and first WAP additional metadata 209. The first client resource usage metadata 206 may indicate the amount of network resources (e.g., average bandwidth, number of packets, number of bytes) used by the first client 121 and the signal properties (e.g., received signal strength) of the first client 121. The first WAP additional metadata 209 may include data related to the operating environment of the first WAP 111 such as the amount of or level of interference experienced by the first WAP. Similarly, the second WAP 112 may send the second WAP metadata 205 to the channel allocator 103. The second WAP metadata 205 may include the second client capability metadata 202, the third client capability metadata 203, second client resource usage metadata 207, third client resource usage metadata 208, and second WAP additional metadata 210. The channel allocator 103 may produce a channel allocation specification 211 in response to receiving the client capability metadata, the client resource usage metadata, and the WAP additional metadata. The client capability metadata received by and used by the channel allocator 103 may include client capability metadata from all the clients. The client resource usage metadata received by and used by the channel allocator 103 may include client resource usage metadata for all the clients. The WAP additional metadata received by and used by the channel allocator 103 may include WAP additional metadata from all the WAPs.

The channel allocator 103 may send the channel allocation specification 211 to the access point controller 104. The channel allocation specification 211 can include a first WAP channel allocation 212 that specifies which channel the first WAP 111 should use and may include a second WAP channel allocation 213 that specifies which channel the second WAP 112 should use. The access point controller may configure the WAPs to use channels specified by the channel allocation specification 211.

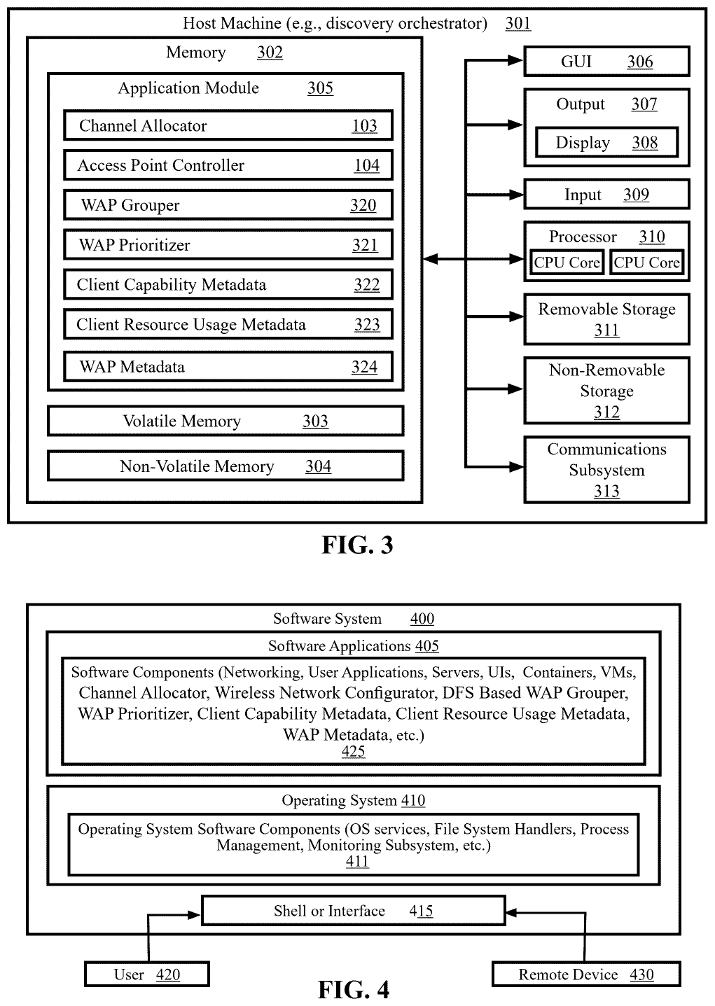

FIG. 3 is a high-level block diagram illustrating an example of a host machine that may implement a channel allocator 103 and an access point controller 104, according to some aspects. A computing device in the form of a host machine 301 configured to interface with controllers, peripheral devices, and other elements may include one or more processing units 310 coupled to memory 302, removable storage 311, and non-removable storage 312. Memory 302 may include volatile memory 303 and non-volatile memory 304. Host machine 301 may include or have access to a computing environment that includes a variety of transitory and non-transitory computer storage media such as volatile memory 303 and non-volatile memory 304, removable storage 311 and non-removable storage 312. Examples of a computer storage medium include random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions and data. Of the listed computer storage media, volatile memory, and most RAM, such as dynamic RAM (DRAM), are transitory computer storage media while the others are considered non-transitory computer storage media.

Host machine 301 may include, or have access to, a computing environment that includes input 309, output 307, and a communications subsystem 313. The host machine 301 may operate in a networked environment using the communications subsystem 313 to connect to one or more remote computers, remote sensors and/or controllers, detection devices, hand-held devices, multi-function devices (MFDs), speakers, mobile devices, tablet devices, mobile phones, wireless access points, smartphones, or other such devices. The remote computer may also be a personal computer (PC), server, router, network PC, radio frequency identification (RFID) enabled device, a peer device or other common network node, etc. The communication connection may connect to a local area network (LAN), a wide area network (WAN), wireless network, Bluetooth connection, or other networks.

Output 307 may be provided as a computer monitor or flat panel display but may include any output device. Output 307 and/or input 309 may include a data collection apparatus associated with host machine 301. In addition, input 309, which may include a computer keyboard, a pointing device such as a computer mouse, computer trackpad, or touch screen allows a user to instruct host machine 301. A user interface can be provided using output 307 and input 309. Output 307 may include a display 308 for displaying data and information for a user, or for interactively displaying a graphical user interface (GUI) 306. A GUI is typically responsive to user inputs entered through input 309 and typically displays images and data on display 308.

Note that the term “GUI” generally refers to a type of environment that represents programs, files, options, and so forth by means of graphically displayed icons, menus, and dialog boxes on a computer monitor screen or smartphone screen. A user can interact with the GUI to select and activate such options by directly touching the screen and/or pointing and clicking with a user input device 309 such as, for example, a pointing device such as a mouse, and/or with a keyboard. A particular item can function in the same manner to the user in all applications because the GUI provides standard software routines (e.g., the application module 305 can include program code in executable instructions, including such software routines) to handle these elements and report the user's actions.

Computer-readable instructions (e.g., program code in application module 305), can include or be representative of software routines, software subroutines, software objects, etc. described herein, are stored on a computer-readable medium and are executable by the processor device (also called a processing unit) 310 of host machine 301. The application module 305 may include computer code and data including, for example, a channel allocator 103, an access point controller 104, a WAP grouper 320, a WAP prioritizer 321, client capability metadata 322, client resource usage metadata 323, and WAP additional metadata 324. The computer code may read, write, or modify data. A hard drive, CD-ROM, RAM, flash memory, and a USB drive are just some examples of a computer storage medium.

FIG. 4 is a high-level block diagram illustrating an example of a software system according to some aspects. The software system 400 may be employed for directing the operation of data-processing systems such as host machine 301. Software applications 405 may be stored in memory 302, on removable storage 311 or on non-removable storage 312, and generally includes and/or is associated with an operating system 410 and a shell or interface 415. One or more application programs may be “loaded” (i.e., transferred from removable storage 311 or non-removable storage 312 into the memory 302) for execution by the host machine 301. Application programs 405 can include software components 425 such as software modules, software subroutines, software objects, network code, user application code, server code, UI code, container code, virtual machine (VM) code, channel allocator code, access point controller code, WAP grouper code, WAP prioritizer code, client capability metadata, client resource usage metadata, WAP metadata, WAP additional metadata, etc. The software system 400 can have multiple software applications each containing software components. The host machine 301 can receive user commands and data through interface 415, which can include input 309, output 307, and communications connection 313 accessible by a user 420 or remote device 430. These inputs may then be acted upon by the host machine 301 in accordance with instructions from operating system 410 and/or software applications 405 and any software components 425 thereof. The operating system may include operating system software components 411 such as operating system services, file system handlers, process management, monitoring subsystem, etc.

Generally, software components 425 can include, but are not limited to, routines, subroutines, software applications, programs, modules, objects (used in object-oriented programs), executable instructions, data structures, etc., that perform specific tasks or implement specific abstract data types and instructions. Moreover, those skilled in the art will appreciate that elements of the disclosed methods and systems may be practiced with other computer system configurations such as, for example, hand-held devices, mobile phones, smartphones, tablet devices, multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, etc.

Note that the terms “component” and “module” as utilized herein may refer to one of or a collection of routines and data structures that perform a particular task or implement a particular data type. Applications and components may be composed of two parts: an interface, which lists the constants, data types, variables, and routines that can be accessed by other modules or routines; and an implementation, which is typically private (accessible only from within the application or component) and which includes source code that implements the routines in the application or component. The terms application or component may also simply refer to an application such as a computer program designed to assist in the performance of a specific task such as word processing, accounting, etc. Components can be built or realized as special purpose hardware components designed to equivalently assist in the performance of a task.

The interface 415 can include a graphical user interface 306 that may display results, whereupon a user 420 or remote device 430 may supply additional inputs or terminate a particular session. In some examples, operating system 410 and GUI 306 can be implemented in the context of a “windows” system. It can be appreciated, of course, that other types of systems are possible. For example, rather than a traditional “windows” system, other operating systems such as, for example, a real time operating system (RTOS) more commonly employed in wireless systems may also be employed with respect to operating system 410 and interface 415. The software application 405 can include, for example, software components 425 that may include instructions for carrying out steps or logical operations such as those shown and described herein.

The description herein is presented with respect to examples that may be implemented in the context of, or require the use of, a data processing system such as host machine 301, in conjunction with program code in an application module 305 in memory 302, software system 400, or host machine 301. The disclosed examples, however, are not limited to any specific application or environment. Instead, those skilled in the art will find that the systems and methods described herein may be advantageously applied to a variety of system and application software including database management systems, word processors, etc. Moreover, the examples may be implemented on a variety of different platforms including Windows, Macintosh, UNIX, LINUX, Android, Arduino, etc. Therefore, the descriptions of the examples which follow are for purposes of illustration and not considered a limitation.

Host machines 301 and software systems 400 can take the form of or run as virtual machines (VMs) or containers that run on physical machines. A VM or container typically supplies an operating environment, appearing to be an operating system, to program code in an application module and software applications 405 running in the VM or container. A single physical computer can run a collection of VMs and containers. In fact, an entire network data processing system including a multitude of host machines 301, LANs and perhaps even WANs or portions thereof can all be virtualized and running within a single computer (or a few computers) running VMs or containers. Those practiced in cloud computing are practiced in the use of VMs, containers, virtualized networks, and related technologies.

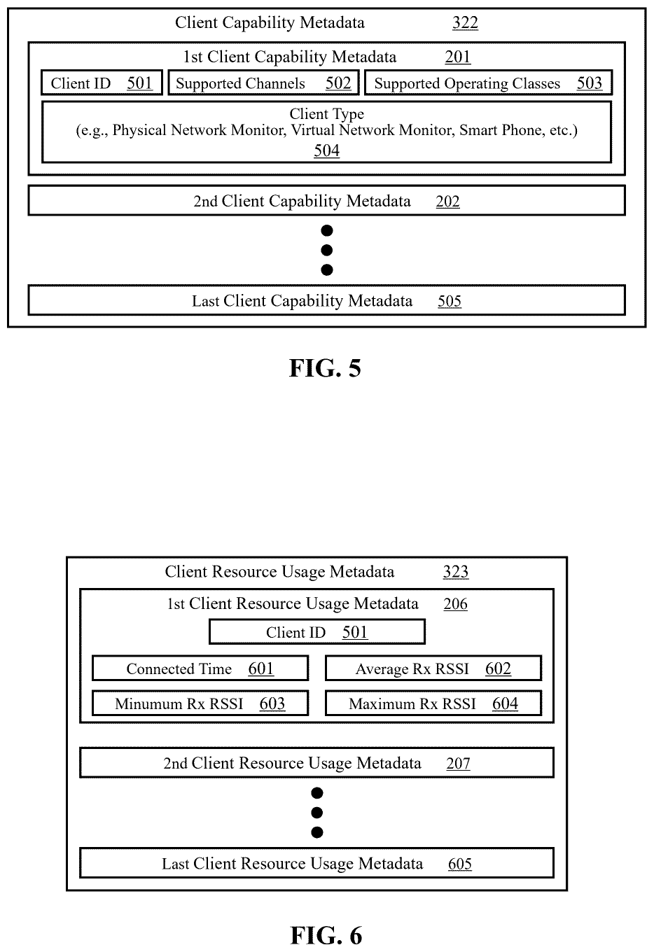

FIG. 5 is a high-level conceptual diagram illustrating an example of client capability metadata 322, according to some aspects. The client capability metadata 322 may include first client capability metadata 201, second client capability metadata 202, and last client capability metadata 505. The first client capability metadata 201 can include a client identifier 501 that may be used for identifying a client, supported channels 502 that may indicate the channels supported by the client, supported operating classes 503 that may indicate the operating classes supported by the client, and a client type 504. The operating classes are specified in the WiFi standards as specific sets of channels. The client type may indicate what type of device the client is. For example, the client may be a printer, a smartphone, a laptop computer, or a network monitor. A network monitor, which may also be referred to as a wireless network monitor, is a device that may measure aspects of the wireless network (e.g., noise levels, devices seen, device's received signal strength, interference levels, channels used by various devices, etc.). The network monitor may be a physical device or may be a virtual device. In an example, the network monitor is a special purpose hardware device that is deployed in a wireless network. In another example, the network monitor is a virtual device implemented by a laptop computer that uses its radio to observe and measure aspects of the wireless network.

FIG. 6 is a high-level conceptual diagram illustrating an example of client resource usage metadata 323, according to some aspects. The client resource usage metadata 323 may include first client resource usage metadata 206, second client resource usage metadata 207, and last client resource usage metadata 605. In the example illustrated in FIG. 2, the first WAP 111 provides network access to the first client 121 and produces the first client resource usage metadata 206. The first client resource usage metadata 206 can include a client identifier 501, connected time 601, average received signal strength indicator 602, minimum received signal strength indicator 603, and maximum received signal strength indicator 604. Connected time 601 may indicate the amount of time that the first client has been connected to the first WAP (e.g., number of seconds over the past 24 hours). The average received signal strength indicator 602 may indicate the average (e.g., averaged over the past 24 hours) of the signal strength measurements of the signal received from the first client. The minimum received signal strength indicator 603 may indicate the minimum (e.g., minimum over the past 24 hours) of the signal strength measurements of the signal received from the first client. The maximum received signal strength indicator 604 may indicate the maximum (e.g., maximum over the past 24 hours) of the signal strength measurements of the signal received from the first client.

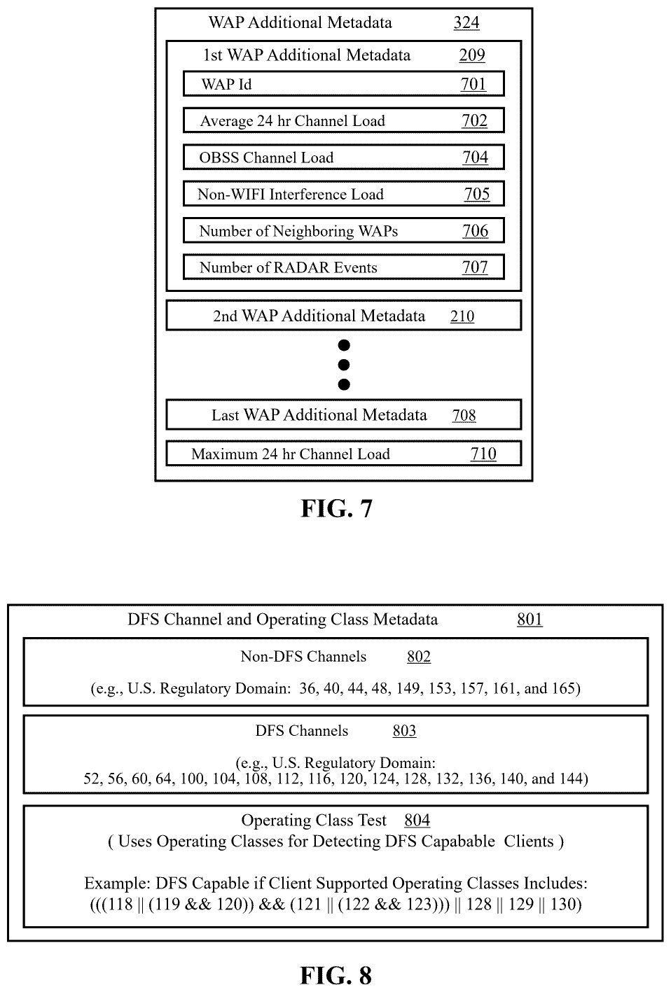

FIG. 7 is a high-level conceptual diagram illustrating an example of wireless access point (WAP) additional metadata, according to some aspects. The WAP additional metadata 324 may include the first WAP additional metadata 209, second WAP additional metadata 210, and last WAP additional metadata 708. In the example illustrated in FIG. 2, the first WAP produces the first WAP additional metadata 209. The first WAP additional metadata 209 may include a WAP identifier 701, the average 24 hour channel load 702, the overlapping basic service set (OBSS) channel load 704, the non-WiFi interference load 705, the number of neighboring WAPs 706, and the number of radar events 707. The WAP identifier 701 may be used for identifying the WAP. The average 24 hour channel load 702 may be a value that indicates the amount of or percentage of time the channel has been busy either from WiFi communications or from interference. The OBSS channel load 704 may be a value that indicates the amount of or percentage of time the channel has been interfered with by communications on an overlapping basic service set (OBSS). The WiFi standards define OBSS and OBSS channel load. The non-WiFi interference load 705 may be a value that indicates the amount of or percentage of time the channel has been interfered with by non-WiFi devices such as radars. The number of neighboring WAPs 706 may indicate how many other WAPs have been observed by detecting their signals. The number of radar events 707 may indicate how many times the WAP has experienced interference from a device that may be a radar. The WAP additional metadata 324 may include a maximum 24 hour channel load 710. The maximum 24 hour channel load may be the maximum value of the average 24 hour channel loads reported by all the WAPs. The maximum 24 hour channel load 710 may be determined by the channel allocator by comparing the average 24 hour channel loads reported by all the WAPs and identifying the maximum value.

FIG. 8 is a high-level conceptual diagram illustrating an example of DFS channel and operating class metadata 801, according to some aspects. The DFS channel and operating class metadata 801 may differ depending on where the WiFi access points are located because different locations may be in different regulatory domains. The DFS channel and operating class metadata 801 can include a list of non-DFS channels 802, a list of DFS channels 803, and an operating class test 804. The client capability metadata for a client may indicate the client's supported operating classes 503. The operating class test 804 may be used for determining whether the client's supported operating classes 503 indicate that the client is a DFS capable client or a DFS non-capable client. DFS non-capable clients are clients that are not configured to use DFS channels or for some other reason do not support or use DFS channels.

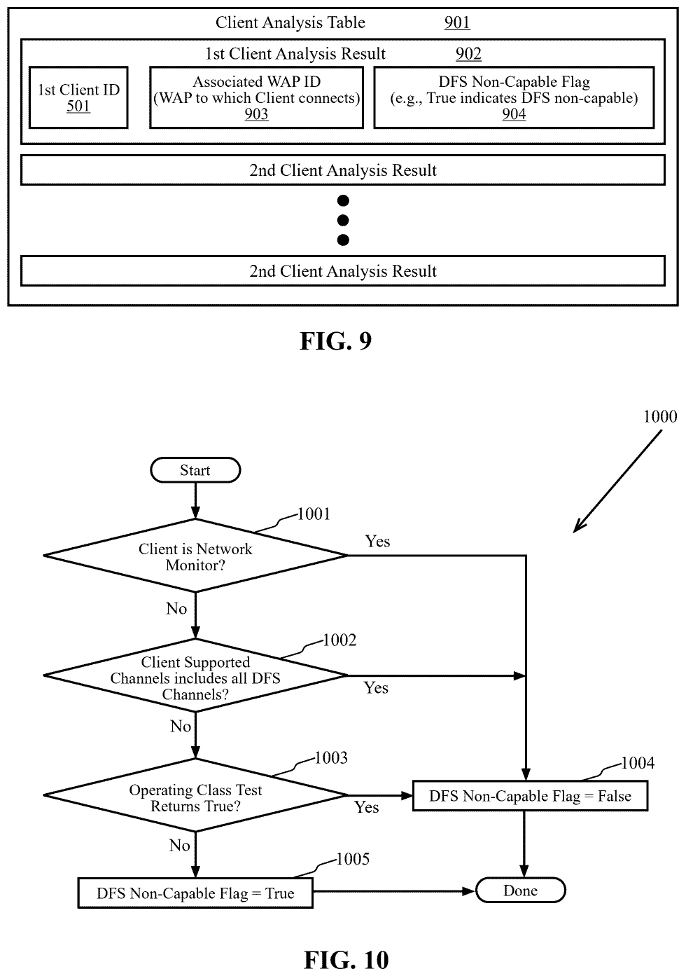

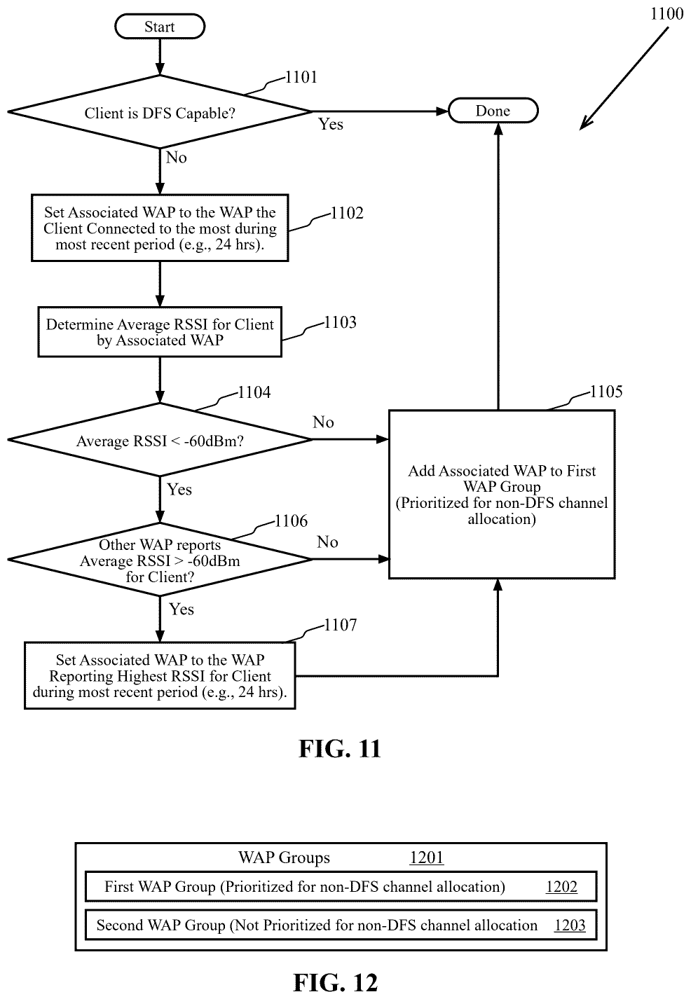

FIG. 9 is a high-level conceptual diagram illustrating an example of a client analysis table 901, according to some aspects. The channel allocator may produce a client analysis table 901 that stores client identifiers in connection with WAP identifiers and DFS non-capable flags. The client analysis table 901 may include a first client analysis result 902 a second client analysis result and a last client analysis result. The first client analysis result 902 can include the client identifier 501 for the first client, an associated WAP identifier 903 that identifies the WAP expected to provide network access to the first client, and a DFS non-capable flag 904 that indicates whether the first client is DFS non-capable. The DFS non-capable flags are DFS capability indicators indicating which of the clients are DFS capable clients and which of the clients are DFS non-capable clients. The process illustrated in FIG. 10 may determine whether a client is DFS non-capable. The process illustrated in FIG. 11 may determine which WAP is expected to provide network access to a client.

FIG. 10 a high-level flow diagram illustrating an example of a process for determining whether a client is a DFS non-capable client 1000, according to some aspects. The process illustrated in FIG. 10 may be implemented by a channel allocator 103 running on a server such as host 301 or cloud server 102. After the start, decision block 1001 may determine whether the client is a WiFi network monitor. The process moves to block 1004 if the client is a network monitor at decision block 1001 and otherwise moves to decision block 1002. At block 1004, the DFS non-capable flag is set to false before the process is done. Decision block 1002 may determine whether the client's supported channels 502 includes all DFS channels 803. The process moves to block 1004 if the client's supported channels 502 includes all DFS channels 803 at decision block 1002 and otherwise moves to decision block 1003. Decision block 1003 may determine whether the operating class test 804 indicates that the client is DFS capable. The process moves to block 1004 if the operating class test 804 indicates that the client is DFS capable at decision block 1003 and otherwise moves to block 1005. At block 1005, the DFS non-capable flag is set to true before the process is done. In an example, the DFS non-capable flag 904 having a value of TRUE or “1” indicates that the client identified by the first client identifier 501 is a DFS non-capable client. DFS non-capable clients are clients that are not configured to use DFS channels or for some other reason do not support or use DFS channels. The DFS non-capable flag 904 having a value of FALSE or “0” indicates that the client identified by the first client identifier 501 is a DFS capable client. DFS capable clients are configured to use DFS channels. Each of the decision blocks may be interpreted as a test for a DFS capability criterion such that the DFS non-capable flag is set if the client does not meet any of the DFS capability criteria.

FIG. 11 a high-level flow diagram illustrating an example of a process for identifying the WAPs that provide network access to DFS non-capable clients 1100, according to some aspects. The WAPs may be divided into two groups of WAPs where the first group includes the WAPs that provide network access to at least one DFS non-capable client and the second group is all the other WAPs. More specifically, the second group includes the WAPs that provide network access to DFS capable clients but not to DFS non-capable clients.

The process illustrated in FIG. 11 may be implemented by the WAP grouper 320 run by the host machine 301. For example, the cloud server 102 may be a host machine that runs the channel allocator 103, access point controller 104, WAP grouper 320, and WAP prioritizer 321. Some implementations may implement the WAP grouper 320 and the WAP prioritizer 321 within the channel allocator 103 (e.g., as subroutines). After the start, decision block 1101 may determine whether the client is DFS capable (e.g., by checking the DFS non-capable flag in the client's analysis result). The process is done if the client is DFS capable at decision block 1101 and otherwise moves to block 1102. At block 1102, the associated WAP field in the client's analysis result may be set to indicate the WAP the client connected to the most during the most recent period (e.g., 24 hrs.). The client resource usage metadata may be used to identify the WAP the client connected to the most during the most recent period. If only one WAP produces client resource metadata for the client, then the associated WAP field may be set to indicate that WAP. If multiple WAPs produced client resource metadata for the client, then the connected time fields (e.g., connected time 601) may be compared to identify the WAP that the client connected to the most during the most recent period. At block 1103 the average received signal strength indicator (Rx RSSI) reported by the associated WAP for the client is determined (e.g., read the average Rx RSSI 602 field in the client resource usage metadata). Decision block 1104 compares the average Rx RSSI to a threshold value (e.g., 60 dBm). The process moves to decision block 1106 if the average Rx RSSI is less than the threshold value and otherwise moves to block 1105. At block 1105, the WAP identified in the client's analysis result is added to the first group of WAPs. Decision block 1106 determines whether any WAP reported an average Rx RSSI above the threshold value (e.g., 60 dBm) for the client. The process moves to block 1107 if any WAP reported an average Rx RSSI above the threshold value for the client and otherwise moves to block 1105. At block 1107,, the associated WAP field in the client's analysis result may be set to indicate the WAP that reported the highest Rx RSSI for the client. The process moves from block 1107 to block 1105. The process illustrated in FIG. 11 may be repeated for every client to thereby identify all of the WAPs in the first group.

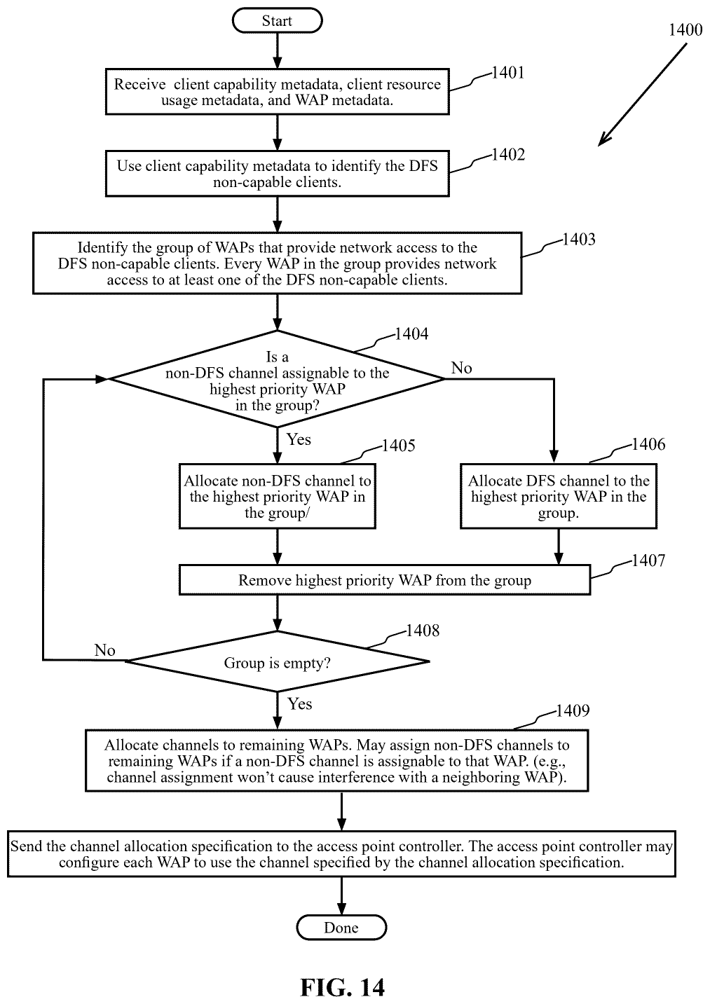

FIG. 12 is a high-level conceptual diagram illustrating an example of WAP groups 1201, according to some aspects. The WAP groups 1201 includes a first WAP group 1202 and a second WAP group 1203. The process illustrated in FIG. 11 may be used to set the first WAP group to include all the WAPs that provide network access to at least one DFS non-capable client. All the other WAPs may be placed in the second WAP group 1203. As such, the first WAP group includes all the WAPs that provide network access to at least one DFS non-capable client. The second WAP group includes all the other WAPs, which are the WAPs that provide network access to DFS capable clients but not to DFS non-capable clients. The WAPs in the first group may be prioritized for DFS channel allocation. FIG. 14 illustrates an example of a process that prioritizes allocation of non-DFS channels to the WAPs in the first group.

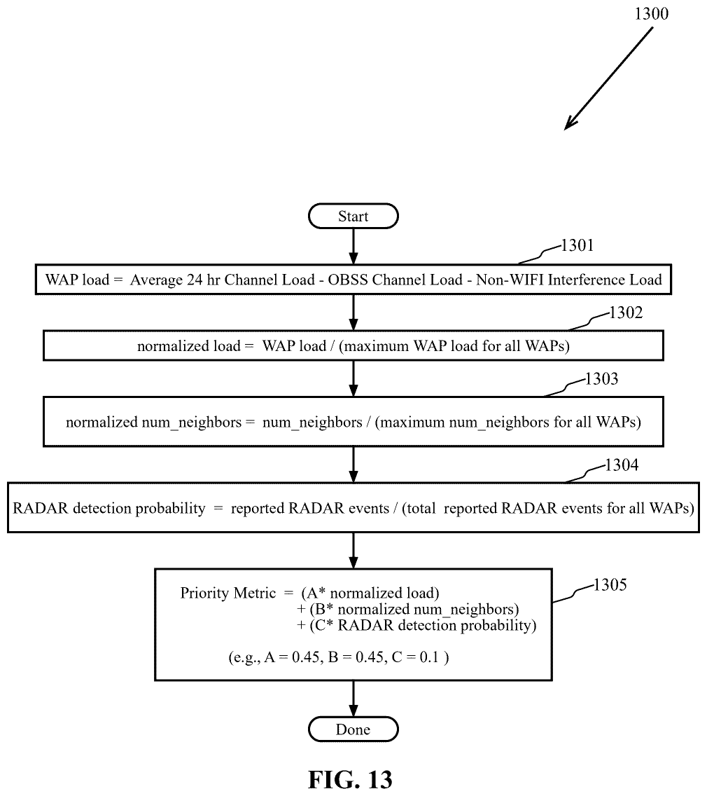

FIG. 13 a high-level flow diagram illustrating an example of a process for calculating a priority metric 1300, according to some aspects. The WAP prioritizer may implement the process illustrated in FIG. 13 and may use the values in the WAP additional metadata for a WAP (e.g., first WAP additional metadata 209) to calculate the priority metric for that WAP. At block 1301, the WAP load may be calculated by subtracting the OBSS channel load 704 and the non-WiFi interference load 705 from the average 24 hour channel load 702. At block 1302, the normalized load may be calculated by dividing the WAP load by the maximum WAP load for all the WAPs. Here, the WAP load has been calculated for every WAP to determine which of the WAP loads is the maximum WAP load for all the WAPs. At block 1303, the normalized number of neighbors may be calculated by dividing the number of neighboring WAPs 706 by the maximum number of neighbors for all the WAPs. Here, numbers of neighboring WAPs reported by all the WAPs have been compared to determine which is the maximum number of neighbors. At block 1304, the radar detection probability may be calculated by dividing the number of radar events 707 by the total number of radar events reported by all of the WAPs. Here, the numbers of radar events reported by all the WAPs have been summed to determine the total number of radar events reported by all of the WAPs. At block 1305, the priority metric for the WAP may be calculated as a weighted sum of the normalized load, the normalized number of neighbors, and the radar detection probability.

FIG. 14 a high-level flow diagram illustrating an example of a process for producing a channel allocation specification 1400, according to some aspects. The process illustrated in FIG. 14 may be implemented within a channel allocator 103 that may be an application run by a host machine 301 (e.g., cloud server 102). At block 1401, WAP metadata may be received. The WAP metadata may include client capability metadata, client resource usage metadata, and WAP additional metadata. At block 1402, the client capability metadata may be used to identify the DFS non-capable clients. FIG. 10 provides an example of a process that may use the client capability metadata to identify the DFS non-capable clients.

At block 1403, the group of WAPs that provide network access to the DFS non-capable clients is determined. FIG. 11 provides an example of a process that may determine the group of WAPs that provide network access to the DFS non-capable clients. Block 1403 prioritizes allocation of non-DFS channels to the WAPs in the group that provides network access to the DFS non-capable clients. Decision block 1404 determines whether a non-DFS channel is assignable to the highest priority WAP in the group. The highest priority WAP may be the WAP having the highest value for a priority metric such as the priority metric calculated by the process illustrated in FIG. 13. Here, non-DFS channels may have already been allocated to higher priority WAPs. A channel is assignable to a WAP if the WAP will not interfere with those higher priority WAPs while using the channel. The process moves to block 1405 if a non-DFS channel is assignable to the highest priority WAP in the group and otherwise moves to block 1406. At block 1405, a non-DFS channel is assigned to the highest priority WAP in the group. At block 1406, a DFS channel is assigned to the highest priority WAP in the group.

At block 1407, the highest priority WAP in the group is removed from the group. Decision block 1408 determines whether the group is empty. The process moves to block 1409 if the group is empty at decision block 1408 and otherwise loops back to decision block 1404. Blocks 1404, 1405, 1406, 1407, and 1408 prioritize allocation of the non-DFS channels within the group based on a plurality of prioritization values (e.g., the values calculated for the prioritization metric) corresponding to the wireless access points. At block 1409, channels are allocated to the remaining WAPs (e.g., the WAPs in the second WAP group 1203). A non-DFS channel may be assigned to one or more of the remaining WAPs if that non-DFS channel is assignable to that WAP. For example, a loop similar to that of blocks 1404, 1405, 1406, 1407, and 1408 may be used to assign channels to the WAPs in the second group. In such an example, allocation of channels to the WAPs in the second group is prioritized by the prioritization metric.

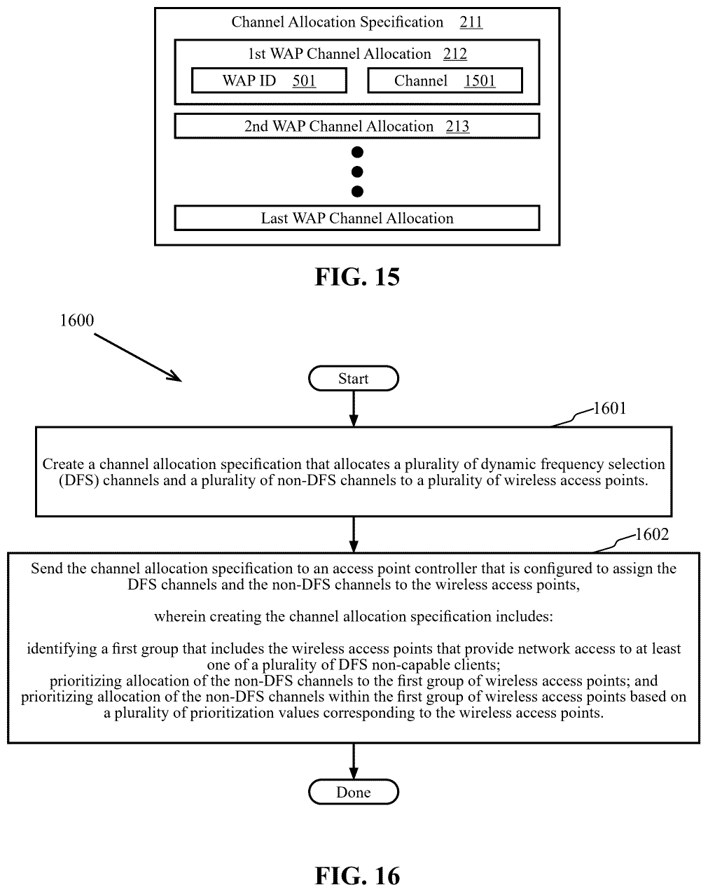

FIG. 15 is a high-level conceptual diagram illustrating an example of a channel allocation specification 211, according to some aspects. The channel allocation specification 211 may include a first WAP channel allocation 212, a second WAP channel allocation 213, and a last WAP channel allocation. The first WAP channel allocation may include a WAP identifier 701 that indicates the first WAP 111 and a channel indicator 1501 that indicates which channel has been allocated to the first WAP 111.

FIG. 16 a high-level flow diagram illustrating an example of a method for creating a channel allocation specification 1600, according to some aspects. At block 1601, a channel allocation specification may be created. The channel allocation specification allocates a plurality of dynamic frequency selection (DFS) channels and a plurality of non-DFS channels to a plurality of wireless access points. At block 1602, the channel allocation specification may be sent to an access point controller that is configured to assign the DFS channels and the non-DFS channels to the wireless access points. Creating the channel allocation specification may include: identifying a first group that includes the wireless access points that provide network access to at least one of a plurality of DFS non-capable clients; prioritizing allocation of the non-DFS channels to the first group of wireless access points; and prioritizing allocation of the non-DFS channels within the first group of wireless access points based on a plurality of prioritization values corresponding to the wireless access points.

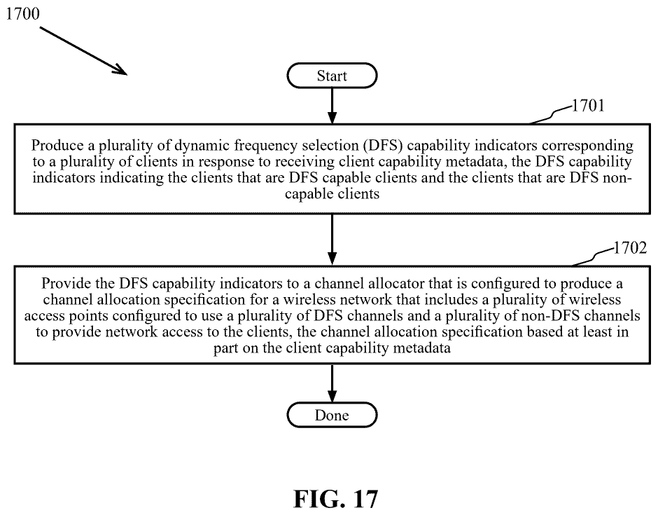

FIG. 17 a high-level flow diagram illustrating an example of a method for creating a channel allocation specification that is sent to an access point controller 1700, according to some aspects. At block 1701, a plurality of dynamic frequency selection (DFS) capability indicators corresponding to a plurality of clients may be produced in response to receiving client capability metadata, the DFS capability indicators indicating the clients that are DFS capable clients and the clients that are DFS non-capable clients. At block 1702, the DFS capability indicators may be provided to a channel allocator that is configured to produce a channel allocation specification for a wireless network that includes a plurality of wireless access points configured to use a plurality of DFS channels and a plurality of non-DFS channels to provide network access to the clients, the channel allocation specification based at least in part on the client capability metadata

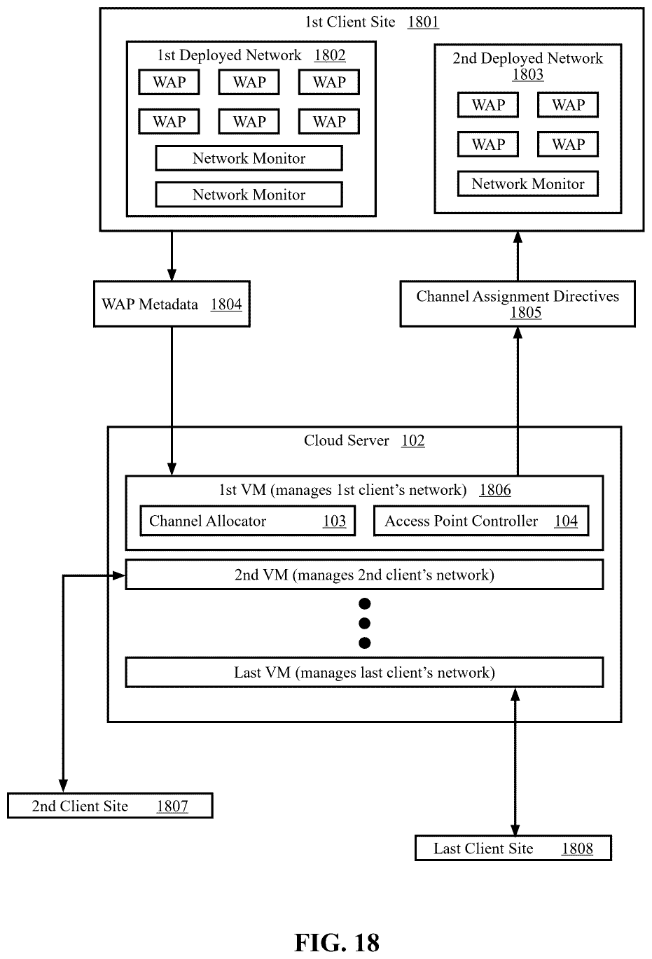

FIG. 18 a high-level flow diagram illustrating an example of a cloud service, according to some aspects. In the example shown in FIG. 18, a communications system includes a cloud server 102, and networks deployed at client sites such as a first client site 1801, a second client site 1807, and a last client site 1808. The first client site 1801 is shown with a first deployed network 1802 and a second deployed network 1803. The cloud server and/or the networks may be implemented in hardware (e.g., circuits), software, firmware, or a combination thereof. Although the illustrated communications system is shown with certain components and described with certain functionality, other embodiments of the communications system may include fewer or more components to implement the same, less, or more functionality. For example, the communications system may include more than one cloud server, and more or fewer deployed networks at more or fewer customer sites. In another example, the cloud server and the deployed networks may be connected in a topology other than that shown in FIG. 18. The cloud server 102 can be used to provide at least one service to a customer site (e.g., to the deployed networks 1802, 1803 located at the first customer site 1801). The cloud server may be configured to facilitate or perform a network management service (e.g., a WAP channel allocation and assignment service) to network devices (e.g., the WAPs in the deployed networks) at the customer sites. Because the cloud server can facilitate or perform a network management service or operation for network devices at the customer site, network management efficiency can be improved. In addition, because the cloud server can facilitate or perform a network management service or operation for network devices at the customer site, the channel allocations and assignments may be implemented without requiring a user or customer of the client site to be trained for or to perform such tasks. Consequently, device and/or network channel allocations may be implemented without burdening the clients. In some examples, the cloud server may be configured to generate a user interface to obtain input information such as a floor plan of a customer site. In some examples, the user interface includes a graphical user interface. The cloud server may be implemented in hardware (e.g., circuits), software, firmware, or a combination thereof. In some examples, the cloud server is hosted or executed in a public cloud computing environment such as Amazon Web Services (AWS), and/or a private cloud computing environment such as an enterprise cloud server. In some examples, the cloud server is implemented on a server grade hardware platform, such as an x86 architecture platform. The hardware platform may be configured to generate and/or transmit channel assignment directives 1805 to the network devices at a client site. In some examples, a WAP can operate on a channel specified by a channel assignment directive in response to receiving the channel assignment directive.

The cloud server 102 is shown running multiple virtual machines (VMs) that may each run a channel allocator and an access point controller. For example, the first virtual machine (VM) 1806 is shown running a channel allocator 103 and an access point controller 104 for the deployed networks 1802, 1803 at the first client site 1801. In other examples, there may be a separate VM for each deployed network. The channel allocator 103 in the first VM 1806 can produce a channel allocation specification in response to receiving WAP metadata 1804 from the WAPs in the deployed networks. The access point controller 104 in the first VM can produce the channel assignment directives 1805 in response to receiving the channel allocation specification. The WAPs at the customer site may switch to the channels specified by the channel assignment directives.

Although the operations of the methods and processes may be shown and described in a particular order, the order of the operations may be altered so that certain operations may be performed in an inverse order or so that certain operations may be performed, at least in part, concurrently with other operations. Alternatively, instructions or sub-operations of distinct operations may be implemented in an intermittent and/or alternating manner.

While the above-described techniques are described in a general context, those skilled in the art will recognize that the above-described techniques may be implemented in software, hardware, firmware, or any combination thereof. The above-described examples may also be implemented by operating a computer system to execute a sequence of machine-readable instructions. The computer readable instructions, when executed on one or more processors, may implement a method or process. The instructions may reside in various types of computer readable media. An example of a programmed product may include a computer readable medium tangibly storing a program of machine-readable instructions executable by a digital data processor to perform a method or process. The computer readable media may comprise memory (e.g., RAM) contained within the computer. Alternatively, the instructions may be contained in another computer readable media such as a magnetic data storage diskette and directly or indirectly accessed by a computer system. Whether contained in the computer system or elsewhere, the instructions may be stored on a variety of machine readable storage media, such as a hard drive, a solid state drive, a RAID array, magnetic tape, electronic read-only memory, an optical storage device (e.g., CD ROM, WORM, DVD, digital optical tape), paper “punch” cards. In an illustrative example, the machine-readable instructions may comprise lines of compiled C, C++, or similar language code commonly used by those skilled in the programming arts.

The foregoing description of examples will so fully reveal the general nature of the various aspects that others can, by applying current knowledge, readily modify and/or adapt for various applications the examples without departing from the generic concept, and, therefore, such adaptations and modifications should and are intended to be comprehended within the meaning and range of equivalents of the disclosed examples. It is to be understood that the phraseology or terminology employed herein is for the purpose of description and not of limitation. Therefore, those skilled in the art will recognize that the examples herein can be practiced with modification within the spirit and scope of the claims as described herein.

What is claimed is:

1. A method comprising:
producing a plurality of dynamic frequency selection (DFS) capability indicators corresponding to a plurality of clients in response to receiving client capability metadata, the DFS capability indicators indicating the clients that are DFS capable clients and the clients that are DFS non-capable clients; and
providing the DFS capability indicators to a channel allocator that is configured to produce a channel allocation specification for a wireless network that includes a plurality of wireless access points configured to use a plurality of DFS channels and a plurality of non-DFS channels to provide network access to the clients, the channel allocation specification based at least in part on the client capability metadata.

2. The method of claim 1, wherein the client capability metadata is received from the clients via the wireless access points.

3. The method of claim 1, wherein:
producing the DFS capability indicators includes setting the DFS capability indicators to indicate a one of the clients is a DFS capable client in response to determining that the client capability metadata indicates that the one of the clients is a Wi-Fi network monitor.

4. The method of claim 1, wherein:
producing the DFS capability indicators includes setting the DFS capability indicators to indicate a one of the clients is a DFS capable client in response to determining that the client capability metadata indicates that the one of the clients is configured to use a plurality of channels that includes one of the DFS channels.

5. The method of claim 1, wherein:
producing the DFS capability indicators includes setting the DFS capability indicators to indicate a one of the clients is a DFS capable client in response to determining that the client capability metadata indicates that the one of the clients is configured to use a plurality of channels that includes every one of the DFS channels in a current regulatory domain.

6. The method of claim 1, wherein:
producing the DFS capability indicators includes setting the DFS capability indicators to indicate a one of the clients is a DFS capable client in response to determining that the client capability metadata indicates that the one of the clients is configured to use an operating class that includes one of the DFS channels.

7. The method of claim 1, further including:
receiving client resource usage metadata indicating resource usage by the clients; and
associating a DFS noncapable client with a wireless access point based on the client resource usage metadata,
wherein:
the DFS noncapable client is one of the DFS noncapable clients; and
the wireless access point is one of the wireless access points.

8. The method of claim 7, wherein associating the DFS noncapable client with the wireless access point based on the client resource usage metadata includes:
using the client resource usage metadata to determine that a connected time between the DFS noncapable client and the wireless access point is a maximum of a plurality of connected times between the DFS noncapable client and the wireless access points.

9. The method of claim 7, wherein associating the DFS noncapable client with the wireless access point based on the client resource usage metadata includes:
using the client resource usage metadata to determine that a connected time between the DFS noncapable client and the wireless access point is a maximum of a plurality of connected times between the DFS noncapable client and the wireless access points; and
using the client resource usage metadata to determine that an average signal strength between the DFS noncapable client and the wireless access point is a maximum of a plurality of average signal strengths between the DFS noncapable client and the wireless access points.

10. The method of claim 7, wherein associating the DFS noncapable client with the wireless access point based on the client resource usage metadata includes:
using the client resource usage metadata to determine that a connected time between the DFS noncapable client and a second one of the wireless access points is a maximum of a plurality of connected times between the DFS noncapable client and the wireless access points;
using the client resource usage metadata to determine that an average signal strength between the DFS noncapable client and the second one of the wireless access points is below a threshold value; and
using the client resource usage metadata to determine that the average signal strength between the DFS noncapable client and the wireless access point is a maximum of the average signal strengths between the DFS noncapable client and the wireless access points.

11. The method of claim 7, further including:
associating the clients with the wireless access points based on the client resource usage metadata, each client associated with no more than one of the wireless access points;
assigning the wireless access points to a first group or to a second group based on the DFS capability indicators and which of the clients are associated with which of the wireless access points,
wherein:
the wireless access points in the first group are each associated with at least one DFS non-capable client; and
no wireless access point in the second group is associated with any of the DFS non-capable clients.

12. The method of claim 11, further including
producing the channel allocation specification; and
sending the channel allocation specification to an access point controller that is configured to assign the DFS channels and the non-DFS channels to the wireless access points,
wherein:
the channel allocation specification allocates the DFS channels and the non-DFS channels to the wireless access points;
allocating the non-DFS channels to the first group is prioritized over allocating the non-DFS channels to the second group; and
allocation of the non-DFS channels within the first group is prioritized based on a plurality of prioritization values corresponding to the wireless access points.

13. A non-transitory computer storage medium storing computer readable instructions, that when executed on one or more processors, implements a method comprising:
producing a plurality of dynamic frequency selection (DFS) capability indicators corresponding to a plurality of clients in response to receiving client capability metadata, the DFS capability indicators indicating the clients that are DFS capable clients and the clients that are DFS non-capable clients; and
providing the DFS capability indicators to a wireless network configurator that is configured to produce a channel allocation specification for a wireless network that includes a plurality of wireless access points configured to use a plurality of DFS channels and a plurality of non-DFS channels to provide network access to the clients, the channel allocation specification based at least in part on the client capability metadata.

14. The non-transitory computer storage medium storing computer readable instructions of claim 13, wherein:
producing the DFS capability indicators includes setting the DFS capability indicators to indicate a one of the clients is a DFS capable client in response to determining that the client capability metadata indicates that the one of the clients is a Wi-Fi network monitor.

15. The non-transitory computer storage medium storing computer readable instructions of claim 13, wherein:
producing the DFS capability indicators includes setting the DFS capability indicators to indicate a one of the clients is a DFS capable client in response to determining that the client capability metadata indicates that the one of the clients is configured to use a plurality of channels that includes one of the DFS channels.

16. The non-transitory computer storage medium storing computer readable instructions of claim 13, wherein:
producing the DFS capability indicators includes setting the DFS capability indicators to indicate a one of the clients is a DFS capable client in response to determining that the client capability metadata indicates that the one of the clients is configured to use a plurality of channels that includes every one of the DFS channels in a current regulatory domain.

17. The non-transitory computer storage medium storing computer readable instructions of claim 13, wherein:
producing the DFS capability indicators includes setting the DFS capability indicators to indicate a one of the clients is a DFS capable client in response to determining that the client capability metadata indicates that the one of the clients is configured to use an operating class that includes one of the DFS channels.

18. The non-transitory computer storage medium storing computer readable instructions of claim 13, wherein:
the clients are associated with the wireless access points in response to receiving client resource usage metadata, each client associated with no more than one of the wireless access points; and
allocating the non-DFS channels to the wireless access points that are associated with at least one DFS non-capable client is prioritized over allocating the non-DFS channels to the wireless access points that are associated with none of the DFS non-capable clients.

19. A system comprising:
a means for receiving client capability metadata from a plurality of clients that include a plurality of DFS capable clients and a plurality of DFS non-capable clients;
a production means for producing a dynamic frequency selection (DFS) capability indication means for indicating the clients that are the DFS capable clients and the clients that are the DFS non-capable clients;
a provider means for providing the capability indication means to a channel allocator means for producing a channel allocation specification for a plurality of access means for using a plurality of DFS channels and a plurality of non-DFS channels to provide network access to the clients,
wherein:
the production means produces the DFS capability indication means in response to receiving the client capability metadata; and
channel allocator means produces the channel allocation specification in response to receiving the client capability metadata.

20. The system of claim 19, further including:
an association means for associating a DFS noncapable client with a wireless access point based on a client resource usage metadata,
wherein the channel allocator means allocates a non-DFS channel to one of the access means in response to determining that the access means provides network access to a DFS non-capable client.
